(19) United States
(12) Patent Application Publication
(10) Pub. No.: US 2024/0109791 A1
(43) Pub. Date: Apr. 4, 2024

(54) Water Processing Method and Unit

(71) Applicant: Lithium Harvest ApS, Hurup Thy (DK)

(72) Inventors: Paw JUUL, Brønderslev (DK); Sune MATHIESEN, Randers NV (DK)

(21) Appl. No.: 17/956,228

(22) Filed: Sep. 29, 2022

(51) Int. Cl. C02F 1/26; C02F 1/42; C02F 1/44; C22B 3/22; C22B 26/12

(52) U.S. Cl. CPC C02F 1/26; C02F 1/42; C02F 1/444; C22B 3/22; C22B 26/12; C02F 2001/425; C02F 2103/10

(57) ABSTRACT

A method for processing produced water from an oil and/or well is disclosed. The method comprises the step of: a) receiving permeate from pre-treated produced water; or b) filtering the produced water in a filtration unit hereby producing permeate (filtrate) and retentate. The method comprises the step of extracting lithium from the permeate.

### FIELD OF INVENTION

The present invention relates to a method for processing produced water from an oil and/or gas well. The present invention also relates to a process unit for processing produced water from an oil and/or gas well.

Land-based drilling rigs are used for accessing oil and gas stored in beneath the ground. In land based drilling rigs, large quantities of high pressure, extremely hot water are pumped into the petroleum reservoir beneath the ground. The water pressure forces the oil and gas upwards. Moreover, the heat from the forced water lowers the viscosity of the oil and gas. The fluid that returns to the surface is so-called “produced water”. The “produced water” comprises hot gas, oil and water that was trapped underground, as well as the pumped water, along with earth and debris.

When the produced water is received on ground level, oil and gas are extracted to the highest possible extent.

When the oil and gas has been extracted from the “produced water”, the remaining “wastewater” needs to be cleaned in order to eliminate all of the additional oils and other compounds before the cleaned water can be discharged into the environment or re-used through the pressure pumps for repeated cycles of petroleum extraction. Produced water typically contains various toxic organic and inorganic compounds.

In many land-based drilling rigs, however, no such cleaning is possible and therefore new clean water is transported by tank trucks. Moreover, the wastewater is typically transported by a truck to either a storage or to a purification plant. These procedures are very expensive and time consuming.

Land-based cleaning at the drilling rigs can be very challenging since the characteristics and physical properties of the produced water vary considerably depending on the geographic location of the field, the geological formations with which the produced water has been in contact and the type of hydrocarbon product being extracted.

Thus, there is a need for a method and an apparatus which reduces or even eliminates the above mentioned disadvantages of the prior art.

As used herein “produced water” means water separated from the production stream of oil and gas wells (drilling rigs).

### BRIEF DESCRIPTION

The object of the present invention can be achieved by a method as defined in claim 1 and by a process unit as defined in claim 13. Preferred embodiments are defined in the dependent subclaims, explained in the following description and illustrated in the accompanying drawings.

The method according to the invention is a method for processing produced water from an oil and/or gas well, wherein the method comprises the step of extracting oil and/or gas produced water and hereafter carrying out a preliminary concentration process comprising the step of filtering the produced water in a filtration unit hereby producing permeate (filtrate) and retentate, wherein the method comprises the step of extracting lithium from the permeate.

Hereby, it is possible to clean the wastewater (the produced water after oil and/or gas has been extracted) to such an extent that the cleaned water can be discharged into the environment, be used for irrigation or re-used through the pressure pumps for repeated cycles of oil and/or gas extraction. Produced water typically contains various toxic organic and inorganic compounds. At the same time, it is possible to extract lithium and thus process the wastewater in a manner that has a profitable outcome.

Before the preliminary concentration process is carried out, the oil and gas has been extracted from the produced water.

In an embodiment, the preliminary concentration process is carried out a separate step in a first location (e.g. near the well).

In an embodiment, the preliminary concentration process is carried out by using a processing unit according to the invention. The processing unit may be located in a location distance from the well.

In an embodiment, the preliminary concentration process is carried out by using a first treatment unit that is not a part of the processing unit according to the invention. In this embodiment, the processing unit is configured to receive wastewater defined as permeate from the preliminary concentration process that is carried out in order to extract oil and/or gas from the produced water.

In an embodiment, the well is designed for accessing oil stored in beneath the ground.

In an embodiment, the well is designed for accessing gas stored in beneath the ground.

In an embodiment, the well is designed to access oil and gas stored in beneath the ground.

In an embodiment, the method processes produced water from a land-based drilling rig.

In an embodiment, the step of extracting oil and/or gas produced water comprises:
a) a first step, in which electrocoagulation and dissolved air flotation are applied and
b) a second step applying ultrafiltration.

Hereafter, lithium is extracted from the permeate. In an embodiment, the lithium is extracted from the permeate through several process steps.

In an embodiment, the first lithium extracting step comprises a Direct Lithium Extraction process. In this process step (ion-exchange resin method) a selective absorbent is used to extract lithium from the permeate. The solution extracted from the permeate is then polished of impurities to yield high-grade Lithium Carbonate and Lithium Hydroxide.

When the resin is washed away and the “extracted” lithium is released, this water is sent to nanofiltration and Reverse Osmosis filtration for concentration. The permeate from these two processes can be reused for irrigation or as re-injection water. The retentate from the Reverse Osmosis filtration unit must be further processed into Lithium Carbonate.

In an embodiment, the method comprises the following steps:
a) extracting lithium from the permeate is carried out by using an ion-exchange resin method that extracts lithium ions (Direct Lithium Extraction method) or a method that removes divalent metal ions in the permeate and leaves a concentrated lithium fluid and
b) recovery of Li⁺ as precipitates of Li₂CO₃ or LiOH.

In an embodiment, the method comprises the step of extracting lithium by using a precipitation method.

In an embodiment, the method comprises the step of extracting lithium by using an extraction method.

In an embodiment, the method comprises the step of extracting lithium by using a carbonization method.

In an embodiment, the method comprises the step of extracting lithium by using a calcination leaching method.

In an embodiment, the method comprises the step of extracting lithium by using Xu's method (see: Extraction of lithium with functionalized lithium ion-sieves, September 2016, Progress in Materials Science 84).

In an embodiment, the method comprises the step of extracting lithium by using an electrodialysis method.

Lithium can be recovered in multiple ways. FIG. 5 illustrates how adsorbents or ion exchange resins can be used. Adsorbents will absorb lithium ions onto the surface of the adsorbents.

A resin adsorption method is used by utilizing lithium-ion exchange adsorption technology. Either method will extract the lithium from the permeate and ready the solution containing lithium for lithium concentration. The adsorbents can be titanium dioxide, metal phosphates, composite antimonates, aluminum salt adsorbents or organic ion exchange resins, nanometer adsorbents or reactive polymers.

The desorption is done when the absorbent is saturated with lithium. A desorption solution is fed backwards through the adsorption resin tank, and the desorbed lithium is ready for further concentration. The desorption solution can be a variety of desorption solutions: aqueous electrolyte solution, low salinity water, demineralized water, deionized water, saline solution, hydrochloric acid solution, acidic solution, sodium hydroxide solution, alkalic solution.

Further concentration of lithium can be done by employing filtration technologies like nanofiltration and RO (reverse osmosis) filtration. Nanofiltration can be done by utilizing polymer membranes and/or ceramic membranes (materials, SiC, Al2O₃, TiO₃, ZrO₃). This is done to concentrate the lithium before Ca/Mg removal and Li precipitation before ending up with final product lithium carbonate (battery grade).

The permeate (filtered water) from both the nanofiltration and Reverse Osmosis (RO) filtration will partly be used in the above process, but it can also be used for reuse purposes in the oil and gas industry as re-injection water.

In an embodiment, the method comprises the following steps:
a) selectively removing unwanted contaminants from the permeate and/or
b) selectively removing lithium from the permeate.

In an embodiment, the step of extracting lithium from the permeate is carried out by using a Li⁺ selective membrane to carry out a selective membrane filtration.

In an embodiment, the method comprises the following steps:
a) conduction an additional filtrating process after extracting lithium from the permeate and
b) applying the filtrated permeate as fracturing fluid being injected into the well.

In an embodiment, the recovery of Li⁺ (as precipitates of Li₂CO₃ or LiOH) is done by extracting lithium from the resin and recovering Li⁺ as precipitates of Li₂CO₃ or LiOH after a washing process.

In an embodiment, the recovery of Li⁺ (as precipitates of Li₂CO₃ or LiOH) is done by a filtration process (e.g. nanofiltration and/or Reverse Osmosis filtration) in which precipitates of Li₂CO₃ or LiOH are retained.

The step of filtering the produced water in a filtration unit hereby producing permeate (filtrate) and retentate is a pre-treatment that is carried out before the step of extracting lithium from the permeate.

In an embodiment, the filtration unit is an ultrafiltration unit that comprises:
a) flat sheet membranes and/or
b) tubular membranes,
   wherein the membranes are made of:
a ceramic material preferable SiC, Al₂O₃, TiO₃ or ZrO₃ or
a polymer material.

In an embodiment, the ultrafiltration unit comprises ceramic flat sheet membranes arranged in a membrane reactor, wherein granular activated carbon is present in the membrane reactor.

In an embodiment, magnetic water treatment is applied to initiate precipitation of particles.

Magnetic water treatment may be applied to initiate precipitation of particles such as salts (carbonate, chloride and sulphate salts of Ca₂⁺, Mg₂⁺, Fe₂⁺ and Fe₃⁺ cations).

In an embodiment, a first post-processing step is carried out, wherein said first post-processing step concentrates, or purifies an output from a previous method step.

In an embodiment, a second post-processing step is carried out after the first post-processing step, wherein said second post-processing step concentrates or dries an output from the first post-processing step.

The process unit according to the invention is a process unit comprises a separator that is configured to receive and process permeate (filtrate) from the produced water, wherein the separator is arranged and configured to extract lithium from the permeate.

Hereby, it is possible to clean the wastewater (the produced water after oil and/or gas has been extracted) to such an extent that the cleaned water can be discharged into the environment, used for irrigation or re-used through the pressure pumps for repeated cycles of oil and/or gas extraction. Produced water typically contains various toxic organic and inorganic compounds. At the same time, it is possible to extract lithium and thus process the wastewater in a manner that has a profitable outcome.

Before the preliminary concentration process is carried out, the oil and gas has been extracted from the produced water.

The separator is a treatment unit that comprises one or more devices arranged and configured to process the permeate.

In an embodiment, the process unit comprises a filtration unit arranged and configured to extract oil and/or gas from the produced water and hereafter filter the produced water hereby produce permeate (filtrate) and retentate. Hereby, it is possible to process the produced water that comprises oil and/or gas and hereby extract the oil and/or the gas from the produced water.

In an embodiment, the process unit does not comprise a filtration unit arranged and configured to produced water. In this embodiment, the process unit is configured to receive wastewater that has already been treated in a pre-treating unit that is configured to extract oil and/or gas from the produced water.

In an embodiment, the separator is arranged and configured for
a) extracting lithium from the permeate is carried out by using an ion-exchange resin method that extracts lithium ions via a direct extraction method or a method that removes divalent metal ions in the permeate and
b) recovering Li⁺ as precipitates of Li₂CO₃ or LiOH.

In an embodiment, the separator is arranged and configured to
a) selectively removing unwanted contaminants from the permeate and/or
b) selectively removing lithium from the permeate.

In an embodiment, the separator comprises one or more Li⁺ selective membranes that are arranged and configured to extracting lithium from the permeate by carrying out a selective membrane filtration.

In an embodiment, the separator comprises:
a washing unit that is arranged and configured to wash the resin and
an extracting unit that is arranged and configured to extract lithium from the resin and recovering Li⁺ as precipitates of Li₂CO₃ or LiOH when the resin has been treated in the washing unit.

In an embodiment, the separator is configured to recover Li⁺ (as precipitates of Li₂CO₃ or LiOH) by extracting lithium from the resin and recovering Li⁺ as precipitates of Li₂CO₃ or LiOH after a washing process.

In an embodiment, the separator comprises a filter assembly that is arranged and configured to recover Li⁺ (as precipitates of Li₂CO₃ or LiOH) by filtration and hereby retaining precipitates of Li₂CO₃ or LiOH.

In an embodiment, the filtration unit is an ultrafiltration unit that comprises:
a) flat sheet membranes and/or
b) tubular membranes,
   wherein the membranes are made of:
a ceramic material preferable SiC, Al₂O₃, TiO₃ or ZrO₃ or
a polymer material.

In an embodiment, the ultrafiltration unit comprises a number of ceramic flat sheet membranes arranged in a membrane reactor, wherein activated carbon is present in the membrane reactor. In an embodiment, the activated carbon is granular activated carbon.

In an embodiment, the process unit comprises a magnetic water treatment unit that is arranged and configured to initiate precipitation of particles.

In an embodiment, the process unit comprises a first post-processing unit arranged and configured to concentrate or purify an output from a processing unit of the process unit.

In an embodiment, the process unit comprises a second post-processing unit is arranged and configured to concentrate or dry an output from the first post-processing unit.

### BRIEF DESCRIPTION OF THE DRAWINGS

The invention will become more fully understood from the detailed description given herein below. The accompanying drawings are given by way of illustration only, and thus, they are not limitative of the present invention. In the accompanying drawings:

FIG. 1 shows a schematic view of a prior art land-based oil well;

FIG. 2A shows a schematic view of a process unit for processing produced water according to the invention;

FIG. 2B shows a schematic view of the process unit shown in FIG. 2A;

FIG. 3 shows a separator according to the invention;

FIG. 4 shows a separator according to the invention and

FIG. 5 shows how adsorbents or ion exchange resins can be used.

### DETAILED DESCRIPTION

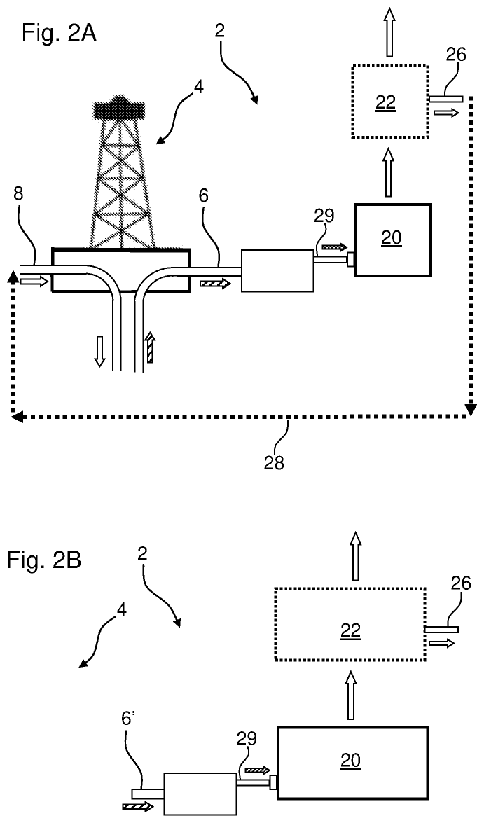

Referring now in detail to the drawings for the purpose of illustrating preferred embodiments of the present invention, a process unit 2 of the present invention is illustrated in FIG. 2.

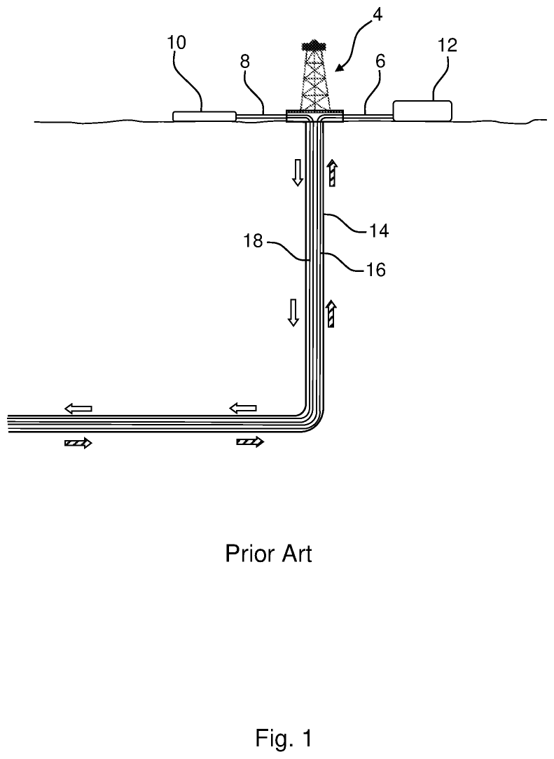

FIG. 1 is a schematic side view of a prior art land-based well (drilling rig) 4 for accessing oil and/or gas. The well 4 comprises a first pipe for pumping pressurised water into the petroleum reservoir beneath the ground. The water pressure forces the oil and gas upwards through a second pipe 16. The first pipe 18 and the second pipe 16 extend inside a casing 14. The first pipe 18 is connected to a fracturing fluid tank 10 via a tube 8. The second pipe 16 is connected to an oil and gas tank 12 via a tube 6.

FIG. 2A illustrates a schematic view of a process unit 2 for processing produced water according to the invention. The process unit 2 is connected to a land-based well (drilling rig) 4 corresponding to the one shown in and explained with reference to FIG. 1.

Like the land-based well shown in FIG. 1, the well 4 comprises a tube 8 that is connected to a fracturing fluid tank (not shown). The tube 8 is in fluid communication with a pipe for injecting pressurised water into the petroleum reservoir beneath the ground.

The process unit 2 comprises a filtration unit 24 arranged and configured to extract oil and/or gas from the produced water and hereafter filter the produced water hereby produce permeate (filtrate) and retentate. Accordingly, the permeate can be processed in order to extract lithium and hereafter be filtered and used as fracturing fluid to be injected into the petroleum reservoir beneath the ground via the tube 8.

The well 4 comprises a tube 6 that is connected to the pipe through which the oil and/or gas containing produced water reached ground level. The tube 6 is connected to the filtration unit 24. In an embodiment, the filtration unit 24 comprises several filtration modules. In an embodiment, the filtration unit 24 comprises a first model (not shown) designed to extract gas and/or oil from the produced water.

When gas and/or oil from the produced water has been extracted from the produced water, the wastewater is cleaned in the filtration unit 24. A first fraction of the cleaned wastewater is guided to a fracturing fluid tank (corresponding to the one shown in FIG. 1) via line 26 and line 28. The process unit 2 comprises a separator 20 arranged and configured to extract lithium from the permeate. The concentrated fraction (retentate) of the wastewater, however, may be processed by using various processing steps. Lithium may be extracted from the permeate by using various techniques.

As indicated, the process unit 2 can optionally comprise an additional treatment unit 22 arranged after the separator 20. The additional treatment unit 22 may be arranged and configured to carry out a filtration process. The additional treatment unit 22 may be arranged and configured to carry out a drying process. It can be seen that clean water is leaving the additional treatment unit 22 through line 26. In an embodiment, clean water may be provided from the separator 20.

FIG. 2B illustrates a schematic view of the process unit 2 shown in FIG. 2A. The process unit 2 is, however, not connected to a well like the one shown in FIG. 2A. The process unit 2 comprises a separator 20 and optionally an additional treatment unit 22 like shown in and explained with reference to FIG. 2A. The process unit 2 may be placed in any suitable and desirable location.

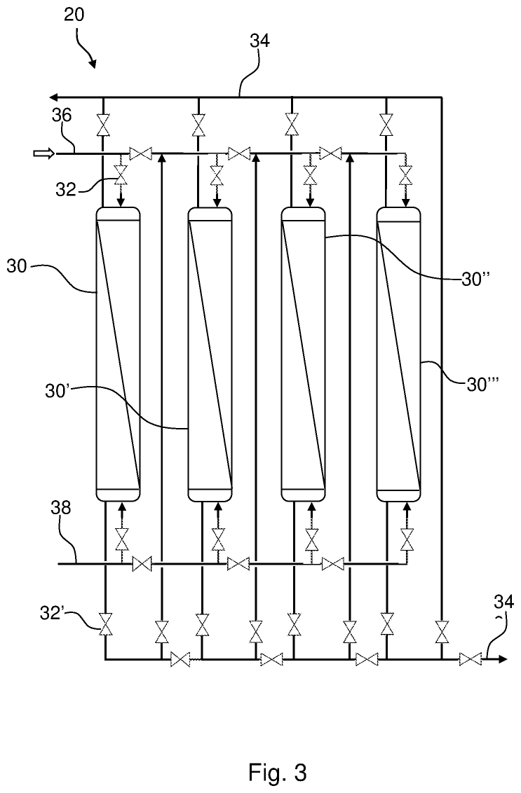

FIG. 3 illustrates a separator 20 according to the invention. The separator 20 comprises several tanks 30, 30′, 30″, 30′″. The tanks 30, 30′, 30″, 30′″ are connected to a forward flow feed line 36 and a reverse flow feed line 38. The tanks 30, 30′, 30″, 30′″ are connected to a forward flow discharge line 34 and a reverse flow discharge line 34.

It is possible to regulate the flow through tanks 30, 30′, 30″, 30′″ can be performed by valves 32, 32′ coupled to the tanks 30, 30′, 30″, 30′″ as shown in FIG. 3. Each tank 30, 30′, 30″, 30′″ may contain a sorbent material as described herein.

The first tank 30 is the first tank to receive fluid flow through forward flow feed line 36. The second 30′ is the second tank to receive fluid flow through the forward flow feed line 36. The third 30″ is the third tank to receive fluid flow through forward flow feed line 36 and the fourth tank 30′″ is the fourth tank to receive fluid flow through forward flow feed line 36.

The separator 20 may be operated in several different modes. When the fluid containing the desired constituent (brine) has been introduced to tank 30 by opening the valves 32 and 32′, the sorbent material in tank 30 begins to absorb constituents in the brine.

When the brine is a lithium-containing brine, the lithium ions are attracted to water molecules in the fluid by the lone pairs of electrons in water molecules. When the lithium ions of the fluid pass near the sorbent absorbing sites, the lithium loses energy by shedding the water molecules and enters the absorbing site. In an embodiment, an ion-exchange resin can be used where the lithium (or another constituent) ion is exchanged with an ion that is currently attached to the resin, where the exchange also results in a lower energy state for the constituent ion and/or energy state of the resin. It is important to underline that it is possible to apply other absorption techniques.

When a fluid containing the desired constituent (brine) flows from the forward flow feed line 36 to the tank 30, the valves 32, 32′ are opened for letting the brine to flow through the tank 30. The brine fluid from the forward flow feed line 36 is allowed to flow through the tank 30 until sorbent material in the tank 30 has started absorbing the desired constituent, and may near saturation, with a desired constituent in the brine fluid from the forward flow feed line 36.

When the desired concentration of constituent has been absorbed by the sorbent, a second fluid (e.g. water) flow flows into the tank 30. As the second fluid flow begins to move through the tank 30, the interface between the brine and the second fluid (the brine-water interface) moves along the length of the tank 30. As the interface passes a certain level in the tank 30, the ions that have been captured in the sorbent may also lose energy by leaving the absorption site and entering the fluid stream in the second fluid.

In the case of lithium, the lithium ion is attracted to a plurality of water molecules in the second fluid. Hereby, these water molecules will place the lithium ion at a lower energy state in the second fluid than if the lithium ion were to remain absorbed (attached) to the sorbent particle. The lithium is flushed or removed from the sorbent and is absorbed by the second fluid.

In an embodiment, once the sorbent material in tank 30 has been completely saturated, a second dilute flow flows into tank 30. This dilute flow may come from the forward flow feed line 36 or from the reverse flow feed line 38. The dilute flow may comprise a dilute solution of the desired constituent dissolved in water and forces the remaining brine (and all of the impurities still present in the brine) from the tank 30 while at least partially filling the tank 30. By keeping a basically constant pressure within tank 30, the structural integrity of the sorbent material in the tank 30 is relatively maintained. The removal of the brine fluid may reduce the impurities that are present when the desired constituent is removed from the tank 30. While filling the tank 30 with the dilute flow, the second tank 30′ may be being filled with brine flow from the forward flow feed line 36. Accordingly, the tank 30 will lead the flow ahead of the second tank 30′. Other valves in the separator 20 may control the flow of brine and/or dilute flow into the tanks 30, 30′, 30″, 30′″.

When the first tank 30 has been filled with the dilute flow, a stripping solution is placed into the tank 30 to remove the desired constituent from the sorbent material in the tank 30. This flow may also come from forward flow feed line 36 or from the reverse flow feed line 38 and regenerates the ability of tank 30 to absorb the desired constituent from a brine fluid flow.

While the first tank 30 is absorbing the desired constituent from the brine flow, the second tank 30′ may be undergoing a dilute flow and third tank 30″ and the fourth 30′″ may be receiving the stripping solution to remove the desired constituent from the sorbent material. Accordingly, the separator 20 may be operated as a continuous sequential flow system, such that the brine flow from the forward flow feed line 36 is continuously flowing into one of the tanks 30, 30′, 30″, 30′″ and the desired constituent is continuously being removed from another of tanks 30, 30′, 30″, 30′″ once an initial cycle through the number of tanks 30, 30′, 30″, 30′″ has been completed.

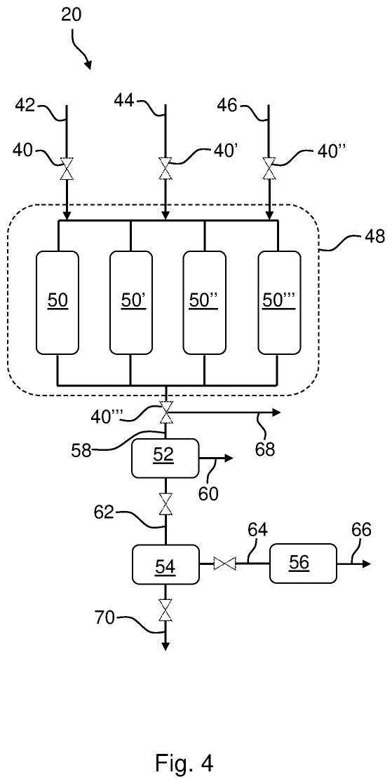

FIG. 4 illustrates a separator 20 according to the invention. The separator 20 comprises a tank assembly 48. In an embodiment, the output of the tank 48 may be purified, e.g., have contaminants removed from the output stream from the tank 48, and may also be concentrated in the system with a concentration membrane.

A purification unit being either of the following: a cross-flow membrane, an ion-exchange resin, solvent extraction system, and/or other purification devices configured to allow the targeted constituent and solvent to pass, or permeate, while retaining or preventing undesired impurities from passing through the purification membrane and/or ion-exchange resin.

The one or more purification membranes may be a nanofiltration membrane, or other type of filtration membrane, having a porosity and/or separation affinity for specific constituents in the output of tank 48 and hereby reduce the levels of impurities to the parts per million levels. The one or more purification membranes may be operated at any suitable pressure. In an embodiment, an ion-exchange resins may be employed to remove polyvalent metal ions, sulphates, borates, and/or other impurities as desired.

In an embodiment, the concentration membrane is configured to separate and/or remove the solvent, typically water, from the stream containing the desired constituent. The concentration membranes may be susceptible to impurity materials affecting the performance of the separation. In an aspect of the present disclosure, a purification membrane, such as a cross-flow membrane may be used prior to the concentration membrane to reduce the effects of impurities on the separator 20.

In an embodiment, a concentration membrane is configured to receive a certain product stream to pass through the purification membrane. The solvent passes through the concentration membrane and the target constituent is rejected and/or retained by the concentration membrane.

In an embodiment, a Reverse Osmosis (RO) unit may be employed as a concentrating membrane. Concentration membranes operated as reverse osmosis systems may concentrate the targeted constituent to weight percentage levels. Concentration membranes operated as reverse osmosis systems may be limited by the osmotic pressure of the solution and the practical limits of the pressure ratings of the single element components.

In an embodiment, the concentration membrane is part of a heating system that boils off some of the liquid in the product stream, as well as an evaporative system that may or may not recover some of the evaporated liquid. In an embodiment, the concentration membrane is an evaporation pond, a boiler system, an evaporative cooler, and/or other systems that concentrate the amount of desired constituent in the product stream.

The purification membrane units and the concentration membrane units may be made up of single elements arranged in arrays. The purification and concentration membrane units can be arranged in arrays and fitted to mobile systems.

In an embodiment, the separator 20 is configured to isolate other targeted constituents such as CO₂ from a feed gas stream. The CO₂ may be applied to produce the final Li₂CO₃ product by reacting the lithium rich brine stream with the separated CO₂. In the case of LiOH production, the raw purification and separator 20 may allow the direct feed to a lithium hydroxide electrolysis system. Accordingly, the purified product will meet the raw purification standards and the system may only employ the secondary purification system to prepare the brine for electrolysis to LiOH. In both these product cases, lithium is the targeted constituent, but other elements may behave in a similar fashion and be targeted in accordance with the present disclosure.

The separator 20 comprises a plurality of tanks 50, 50′, 50″, 50′″, collectively referred to as a tank assembly 48. The tank assembly 48 comprises a filtering unit 52 that may be a purification membrane and/or ion-exchange resin. The tank assembly 48 comprises a first additional treatment 54 that may be a concentration membrane.

The separator 20 comprises valves 40, 40′, 40″ that are arranged and configured to couple one or more of the inlets (brine) 42, the inlet (dilute) 44 and inlet (clean water) 46 to the tanks 50 50′, 50″, 50′″. The valves 40, 40′, 40″ may also regulate the flow and/or flow rate of the inputs 42, 44, 46.

The valve 40′″ is configured to control the flow out from the tank assembly 48 to direct the flow toward the filtering unit 52 or as an output via the line 68. Brine from the line 68 may be recycled to one or more of the inlets 42, 44, 46 and/or to one or more of the tanks 50 50′, 50″, 50′″.

The line 62 from the filtering unit 52 is passed to the first additional treatment unit 54. Another line 60 from the filtering unit 52 may exit the separator 20. Alternative, the line 60 may be recycled back to one or more inlets 42, 44, 46.

The first additional treatment unit 54 is connected to an output line 70 (for exiting the separator 20) or being recycled back to one or more inlets 42, 44, 46. A second output line 64 is connected to a second additional treatment unit 56.

In one embodiment, the separator 20 may be operated as follows. Initially, the valve 40 is opened while the valves 40′, 40″ are closed. Accordingly, the brine inlet 42 can flow through the tank assembly 48.

The brine input 42 may be analysed to determine the concentration of the desired constituent of lithium to determine how long to flow brine input 42 through tank assembly 48. The brine input 42 may be flowed through the tank assembly 48 until one of the tanks (e.g., the first tank 50) is approximately saturated with the desired constituent. The brine input 42 may then be directed toward another tank in the tank assembly 48 (e.g. the second tank 50′). The output 68 may be recycled to the brine input 42 if desired.

When a portion of the tank assembly 48 (e.g. the first tank 50) is saturated with the desired constituent, the flow of brine input 40 is stopped to that portion of the tank assembly 48. Now the valve second 40′ is opened to allow a second flow—the “dilute flow,” “dilute input” or “dilute stream”- to flow into the saturated portion of the tank assembly 48 in such a manner that the dilute flow displaces the remaining brine in the saturated portion of the tank assembly 48. This displacement reduces the particulates and/or other impurities that may be captured by the filtering unit 52, while minimizing the removal of the desired constituent from the tank assembly 48.

The flow rate of dilute input 44 may be measured such that a bed volume, multiple bed volumes, and/or some other desired amount, of dilute input 44 is flowed through the desired portion of the tank assembly 48. Dilute input 44 may be passed through filtration unit 52 or be directed to output line 68 as desired by changing the position of valve 40′″. The position of the valve 40′″ may be changed during the dilute input 44 flow to reduce any losses of desired constituent that may be dislodged from the tank assembly 48 during the dilute input 44 flow.

When a portion of the tank assembly 48 is saturated with the desired constituent, and the dilute input 44 has displaced the brine input 42 in that portion of the tank assembly 48, the valve 40″ is opened and the valve 40′″ is positioned to pass flow from the tank assembly 48 to the filtration unit 52. This flow (the clean flow or clean input 46) removes the desired constituent from the tank assembly 48 and passes the desired constituent in solution to filtration unit 52 and subsequently to the first additional treatment unit 54 and optionally to the second additional treatment unit 56.

The clean input 46 removes the desired constituent from the tank assembly 48 in solution. This solution is then flowed through the filtration unit 52 to remove impurities from the solution prior to the output line 62. Hereafter, the output line 62 is flowed through the first additional treatment unit 54 in order to remove the desired constituent from the flow in the line 62 as a concentrated output through the line 64, while the solvent is removed through output line 70.

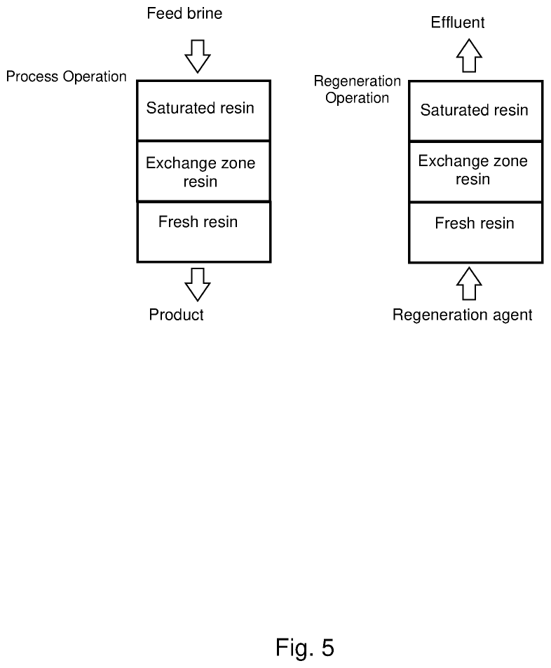

FIG. 5 illustrates how adsorbents or ion exchange resins can be used. Adsorbents will absorb lithium ions onto the surface of the adsorbents.

A resin adsorption method is used by utilizing lithium-ion exchange adsorption technology. Either method will extract the lithium from the permeate and ready the solution containing lithium for lithium concentration. The adsorbents can be titanium dioxide, metal phosphates, composite antimonates, aluminum salt adsorbents, organic ion exchange resins, nanometer adsorbent or reactive polymers.

Desorption is done when the absorbent is saturated with lithium. A desorption solution is fed backwards through the adsorption resin tank, and the desorbed lithium is ready for further concentration. The desorption solution can be a variety of desorption solutions: aqueous electrolyte solution, low salinity water, demineralized water, deionized water, saline solution, hydrochloric acid solution, acidic solution, sodium hydroxide solution, alkalic solution.

Further concentration of lithium can be done by employing filtration technologies like nanofiltration and RO (reverse osmosis) filtration. Nanofiltration can be done by utilizing polymer membranes and/or ceramic membranes (materials, SiC, Al₂O₃, TiO₃, ZrO₃). This is done to concentrate the lithium before Ca/Mg removal and Li precipitation before ending up with final product lithium carbonate (battery grade).

The permeate (filtered water) from both the nanofiltration and Reverse osmosis (RO) filtration will partly be used in the above process, but it can also be used for reuse purposes in the oil and gas industry as re-injection water.

### LIST OF REFERENCE NUMERALS

2 Process unit
4 Well
6, 6′, 8 Tube
10 Fracturing fluid tank
12 Oil and gas tank
14 Casing
16 Pipe
18 Pipe
20 Separator
22 Additional treatment unit
24 Filtration unit
26, 28, 29 Line
30, 30′, 30″, 30′″ Tank
32, 32′ Valve
34 Discharge line
36 Feed line
38 Valve
40, 40′, 40″, 40′″ Valve
42 Inlet (brine)
44 Inlet (dilute)
46 Inlet (clean water)
48 Tank assembly
50, 50′, 50″, 50′″ Tank
52 Filtering unit
54 First additional treatment unit
56 Second additional treatment unit
58, 60, 62 Line
64, 66, 68, 70 Line

What is claimed is:

1. Method for processing produced water from an oil and/or well, wherein the method comprises the step of extracting oil and/or gas produced water and hereafter carrying out a preliminary concentration process comprising the step of filtering the produced water in a filtration unit hereby producing permeate (filtrate) and retentate, wherein the method comprises the step of extracting lithium from the permeate.

2. Method according to claim 1, wherein the method comprises the following steps:
a) conduction an additional filtrating process after extracting lithium from the permeate and
b) applying the filtrated permeate as fracturing fluid being injected into the well.

3. Method according to claim 1, wherein the method comprises the following steps:
a) extracting lithium from the permeate is carried out by using an ion-exchange resin method that extracts lithium ions or a method that removes divalent metal ions in the permeate and leaves a concentrated lithium fluid and
b) recovery of Li⁺ as precipitates of Li₂CO₃ or LiOH.

4. Method according to claim 1, wherein the method comprises the following steps:
a) selectively removing unwanted contaminants from the permeate and/or
b) selectively removing lithium from the permeate.

5. A method according to claim 1, the step of extracting lithium from the permeate is carried out by using a Li⁺ selective membrane to carry out a selective membrane filtration.

6. Method according to claim 3, wherein the recovery of Li⁺ (as precipitates of Li₂CO₃ or LiOH) is done by:
a) extracting lithium from the resin and recovering Li⁺ as precipitates of Li₂CO₃ or LiOH after a washing process.

7. Method according to claim 3, wherein the recovery of Li⁺ (as precipitates of Li₂CO₃ or LiOH) is done by a filtration process in which precipitates of Li₂CO₃ or LiOH are retained.

8. Method according to claim 1, wherein the filtration unit is an ultrafiltration unit comprises:
a) flat sheet membranes and/or
b) tubular membranes,
wherein the membranes are made of:
a ceramic material preferable SiC, Al₂O₃, TiO₃ or ZrO₃ or
a polymer material.

9. Method according to claim 8, wherein the ultrafiltration unit comprises ceramic flat sheet membranes arranged in a membrane reactor, wherein granular activated carbon is present in the membrane reactor.

10. Method according to claim 8, wherein magnetic water treatment is applied to initiate precipitation of particles.

11. A method according to claim 8, wherein a first post-processing step is carried out, wherein said first post-processing step concentrates or purifies an output from a previous method step.

12. A method according to claim 11, wherein a second post-processing step is carried out after the first post-processing step, wherein said second post-processing step concentrates or dries an output from the first post-processing step.

13. Process unit for processing produced water from an oil and/or gas well, wherein the process unit comprises a separator that is configured to receive and process permeate (filtrate) from the produced water, wherein the separator arranged and configured to extract lithium from the permeate.

14. Process unit according to claim 13, wherein the process unit comprises a filtration unit arranged and configured to extract oil and/or gas from the produced water and hereafter filter the produced water hereby produce permeate (filtrate) and retentate.

15. Process unit according to claim 14, wherein the separator is arranged and configured for:
a) extracting lithium from the permeate is carried out by using an ion-exchange resin method that extracts lithium ions or a method that removes divalent metal ions in the permeate and leaves a concentrated lithium fluid and
b) recovering Li⁺ as precipitates of Li₂CO₃ or LiOH.

16. Process unit according to claim 14, wherein the separator is arranged and configured to:
a) selectively removing unwanted contaminants from the permeate and/or
b) selectively removing lithium from the permeate.

17. Process unit according to claim 14, wherein the separator comprises one or more Li⁺ selective membranes that are arranged and configured to extracting lithium from the permeate by carrying out a selective membrane filtration.

18. Process unit according to one of the claim 14, wherein the separator comprises:
a washing unit that is arranged and configured to wash the resin and
an extracting unit that is arranged and configured to extract lithium from the resin and recovering Li⁺ as precipitates of Li₂CO₃ or LiOH when the resin has been treated in the washing unit.

19. Process unit according to claim 14, wherein the separator is configured to recover Li⁺ (as precipitates of Li₂CO₃ or LiOH) by extracting lithium from the resin and recovering Li⁺ as precipitates of Li₂CO₃ or LiOH after a washing process.

20. Process unit according to claim 14, wherein the separator comprises a filter assembly that is arranged and configured to recover Li⁺ (as precipitates of Li₂CO₃ or LiOH) by filtration and hereby retaining precipitates of Li₂CO₃ or LiOH.

21. Process unit according to claim 1, wherein the filtration unit is an ultrafiltration unit comprises:
a) flat sheet membranes and/or
b) tubular membranes,
wherein the membranes are made of:
a ceramic material preferable SiC, Al₂O₃, TiO₃ or ZrO₃ or
a polymer material.

22. Process unit according to claim 14, wherein the ultrafiltration unit comprises a number of ceramic flat sheet membranes arranged in a membrane reactor, wherein granular activated carbon is present in the membrane reactor.

23. Process unit according to one of the claim 14, wherein the process unit comprises a magnetic water treatment unit that is arranged and configured to initiate precipitation of particles.

24. Process unit according to claim 14, wherein the process unit comprises a first post-processing unit arranged and configured to concentrate or purify an output from a processing unit of the process unit.

25. Process unit according to claim 24, wherein the process unit comprises a second post-processing unit is arranged and configured to concentrate or dry an output from the first post-processing unit.
